(19) United States
(12) Patent Application Publication
(10) Pub. No.: US 2017/0192840 A1
(43) Pub. Date: Jul. 6, 2017

(54) COMPUTER DEVICE ERROR INSTRUCTIONS

(71) Applicant: HEWLETT-PACKARD DEVELOPMENT COMPANY, LP, HOUSTON, TX (US)

(72) Inventors: JEFFREY KEVIN JEANSONNE, HOUSTON, TX (US); VALI ALI, HOUSTON, TX (US); DUANE J GATLIN, HOUSTON, TX (US)

(21) Appl. No.: 15/313,111

(22) PCT Filed: Aug. 26, 2014
(86) PCT No.: PCT/US14/52711

§ 371 Date: Nov. 22, 2016

(51) Int. Cl. G06F 11/07; G06F 11/30; G06F 11/00

(52) U.S. Cl. CPC G06F 11/0784; G06F 11/0793; G06F 11/006; G06F 11/3065; G06F 11/0766; G06F 2201/865

(57) ABSTRACT

According to an example of providing an instruction to resolve a computing device error, a connection with a first computing device is established and an error code and an identifier from the first computing device are received. An instruction associated with the error code is fetched, and contact information for a user of the first computing device is determined. The instruction is transmitted to the user of the first computing device, wherein transmitting the instruction to the user of the first computing device comprises transmitting the instruction to a second computing device.

### BACKGROUND

Computing systems, devices, and electronic components in general may experience errors, faults, and other issues during a system boot process or generally during operation of the system, device, or component. Such errors may relate to hardware, firmware, and/or software. Users or administrators of the device may be responsible for troubleshooting the error to restore the device to normal operation.

### BRIEF DESCRIPTION OF THE DRAWINGS

FIG. 1 illustrates a diagram of a computing system, according to an example of the present disclosure;

FIG. 2 illustrates a flowchart of transmitting an error code from a primary device, e.g., primary devices 104, to a cloud service, e.g., cloud server 120, according to an example of the present disclosure;

FIG. 3 illustrates a flowchart of receiving an error code from a primary device, e.g., primary devices 104, on a cloud service, e.g., cloud server 120, according to an example of the present disclosure;

FIG. 4 illustrates a flowchart of receiving a report on a cloud service, e.g., cloud server 120, from a user, according to an example of the present disclosure; and

FIG. 5 illustrates a schematic representation of a computing device that may be used as a platform for implementing or executing at least one of the processes depicted in FIGS. 2-4 according to an example of the present disclosure.

### DETAILED DESCRIPTION

Computing systems, devices, and components such as desktop computers, laptop computers, servers, tablets, smartphones, printers, scanners, networking equipment, individual components, workstations, thin clients, and retail point of sale devices, and other computing equipment (hereinafter “device” or “devices”) may experience errors during the boot, wake, resume, or sleep stages or during operation of the device in general. For example, a desktop computer may fail to properly boot due to a disk drive error, a laptop computer may fail to boot due to a faulty memory chip, a notebook may fail to boot due to a corrupted BIOS flash, or a server may fail to boot due to a temperature threshold being exceeded or insufficient power for a particular blade in a blade server chassis.

Other errors may also occur that do not necessarily prevent a device from booting, but which may nonetheless result in improper operation of the device. For example, a system may boot following failure of a CMOS battery, but with an incorrect or unknown system time. Other errors may also occur related to system firmware or software, such as a Basic Input Output System (“BIOS”) or Advanced Configuration and Power Interface (ACPI).

A device may generate error codes upon detection of an error or generally upon a system failure. Such error codes may be cryptic or require conversion or explanation, especially in cases where error is generated prior to startup of a system BIOS or an operating system. For example, a device that fails to start due to a heat-related failure caused by a build-up of dust in a critical cooling area tray simply display a “blink code” on a LED mounted on a device, or use a system speaker to sound an audible tone or beep corresponding to a code. In either case, a blink code or beep may be of little value to a user of a device, or even a trained technician, without further investigation or explanation. Further, it may be difficult for a user to capture such a code, such as a beep that may only repeat once or twice.

Even in cases where a user may be able to determine or decipher an error code on a device, the code itself may be of little value in diagnosing or resolving the error. Moreover, the manufacturer or distributor of the device may not have a mechanism to log or review such errors across devices that are manufactured or sold, and similarly may not be able to track the effectiveness of troubleshooting instructions for error codes. Unnecessary service calls and/or warranty claims may be required as a result.

According to an example of providing an instruction to resolve a computer device error, a connection with/from a first computing device is established and an error code and an identifier from the first computing device is sent/received. An instruction associated with the error code is fetched, and contact information for a user of the first computing device is determined. The instruction is transmitted to the user of the first computing device, wherein transmitting the instruction to the user of the first computing device comprises transmitting the instruction to a second computing device.

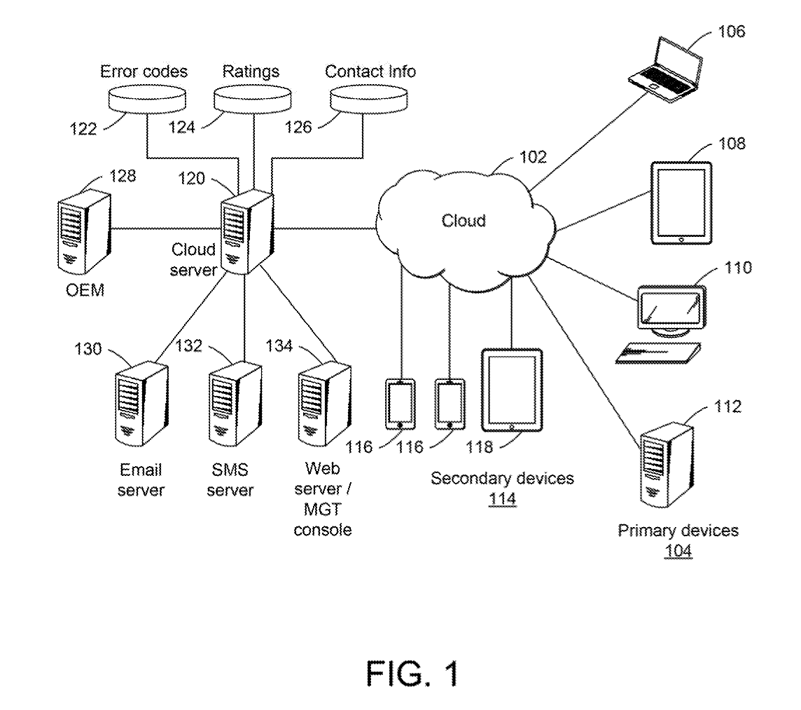

FIG. 1 illustrates a diagram of a computing system according to an example of the present disclosure. In an example, FIG. 1 may represent a cloud-based computing system, with cloud-connected or network-connected devices, or other local or remote computing devices.

In an example, primary devices 104 may include devices such as laptop 106, tablet 108, desktop computer 110, and server 112. Primary devices 104, in the example of FIG. 1, represent devices which may experience errors or other issues when hooting, or generally during operation, at the hardware, firmware, or software level.

In an example, secondary devices 114 may include portable devices such as smartphones 116, tablet 118, or other devices capable of receiving electronic communications such as electronic mail (“e-mail”) or short message service (“SMS”). Secondary devices 114, in the example of FIG. 1, represent devices which may receive instructions for resolving errors on primary devices 104. In some examples, non-mobile devices may also be used as secondary devices 114, such as a desktop computer used to receive e-mail on an e-mail client or to access web-based e-mail.

In an example, cloud server 120 may be a server for providing cloud services and, as discussed below in more detail, for receiving reports of errors from primary devices, fetching instructions for resolving the errors, and transmitting instructions for a user or administrator (hereinafter “user”) of a primary device to the user's secondary device. In sonic examples, users of primary devices 104 and secondary devices 114 may enroll with cloud server 120 through a registration process, such as when purchasing a new device.

In an example, cloud server 120 may be, coupled to or communicate with one or more databases. Error codes database 122 may comprise a database of error codes matching those that may be received from primary devices 104, along with instructions for resolving or troubleshooting the errors. Ratings database 124 may comprise ratings or feedback from users relating to the instructions stored in error codes database 122. Contact information database 126 may store contact information such as e-mail addresses, telephone numbers, or SMS addresses for secondary devices of users, along with primary device identifiers used by a user. Given a primary device identifier, it may possible in some examples to look up the contact information for the user of a device.

As one example, cloud server 120 may receive a memory error code from a primary device 104, look up the rode in error code database 122, and fetch an instruction from the error code database 122 with troubleshooting instructions or a possible solution, e.g., an instruction to re-seat a memory chip. As discussed below in more detail, error code database 122 may determine from ratings database 124 which instruction to fetch, if more than one instruction for a single error code is available. Error code database 122 may also be a learning database.

Cloud server 120 may also determine contact information for a user associated with the primary device 104 reporting an error, and transmit the instruction to the contact address, e.g., for receipt on a secondary device 114.

Cloud server 120 may also be coupled to or communicate with an original equipment manufacturer (“OEM”) 128. For example, the provider of cloud server 120 may transmit error codes, logs, ratings, field reports, analytics, statistics, or other information received, generated, or processed by the cloud server 120 back to an OEM. Such information may be valuable to an OEM for diagnosing issues with products, e.g., with primary devices 104, for summarizing errors and other information for IT administrators or OEMs, or for transmitting new or revised instructions to cloud server 120 for storage in error code database 122. In some examples, the information received or generated on cloud server 120 or at OEM 128 may be used to proactively service or replace components, e.g., a hard disk reporting a SMART error. In other examples, OEMs may use such information to weight purchases of components to suppliers that have fewer issues reported by cloud server 120.

Cloud server 120 may also be coupled to or communicate with an e-mail server 130 or SMS server 132, which may allow the instructions from error code database 122 to be transmitted to the user of a primary device 104 for receipt on the user's secondary device 114. Cloud server 120 may also be coupled to or communicate with a web server or management console 134, which may serve or make accessible a web portal that may provide access to, e.g., error codes, logs, ratings, reports, analytics, statistics, or other information that may be useful to a user or administrator of either cloud server 120 or primary devices 104.

In some examples, the primary devices 104, secondary devices 114, cloud server 120 and associated servers and databases 122-134 may communicate over cloud 102. In various examples, cloud 102 may represent the internet, an intranet; or various public or private networks.

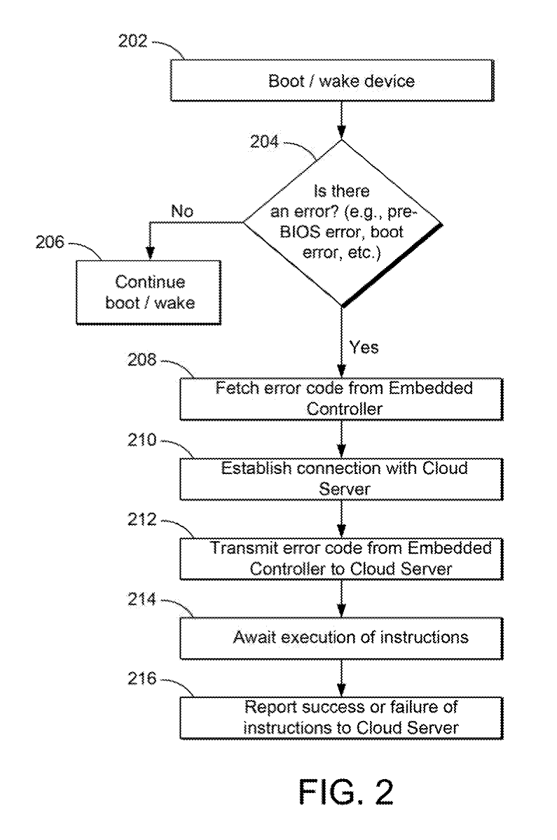

FIG. 2 illustrates a flowchart of transmitting an error code from a primary device, e.g., primary devices 104, to a cloud service, e.g., cloud server 120.

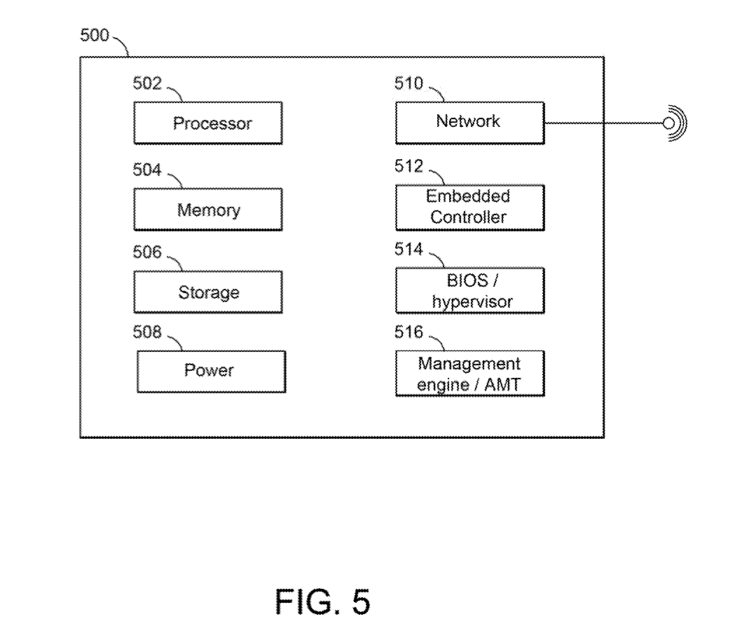

In an example, in block 202, a primary device 104 is booted, waked, resumed, or otherwise brought into a state where power is applied to at least one component of the primary device. For example, in block 202, power is applied to at least an embedded controller, management engine, and network adapter of a device, as discussed below in more detail with respect to FIG. 5. In such an example, the error reporting of FIG. 2 may be carried out even when the primary device 104 is in a low-power, sleep, or hibernate mode. In some examples, the error reporting of FIG. 2 may be carried out even when the primary device 104 is in an off state, e.g., where a processor, memory, or other main components are powered off, but a component such as an embedded controller has access to power.

In block 204, a determination is made as to whether the device is experiencing an error, fault, or other issue. The determination of an error may be made by, for example, an embedded controller on the primary device 104, or other controller or device component capable of determining whether the device is experiencing an error. In some examples, block 204 may occur even prior to the startup or execution of the Basic Input Output System or other system firmware (collectively “BIOS”) of a primary device, such as during a power-on self test “POST”) or as a result of an embedded controller detection step. In various examples, an error may be a pre-BIOS execution error detectable by an embedded controller, such as heat issues or memory chip placement; BIOS boot block (BB) errors; and/or system BIOS (DXE) errors.

In block 206, if no error is detected in block 204, the device may continue to boot, wake, or otherwise resume.

In block 208, if an error is detected in block 204, an error code is fetched, detected, or generated. In one example, an error code may be fetched or detected by an embedded controller coupled to or in communication with a component experiencing an error. In another example, an error code may be generated or returned by a device component itself, e.g., a processor. In another example, an error code may be associated with or mapped to a system blink code. In some examples, other methods of detecting an error in a device may be utilized. In another example, in the case of a pre-BIOS or BIOS boot block error, an error may be passed to an embedded controller from, e.g., the boot block, for further processing as described with respect to FIG. 2.

In block 210, on a periodic basis in one example, a connection is established between the primary device and the cloud server, e.g., cloud server 120. The connection may comprise a non-secure connection or a secure connection, such as Hypertext Transfer Protocol Secure (“HTTPS”) or other secure protocol, and may be established prior to startup or execution of the BIOS of a primary device 104. In some examples, cloud server 120 may also poll a primary device 104 on a pre-determined schedule, such as for mission-critical systems.

In block 212, the error code fetched in block 208 is transmitted from the primary device 104 to the cloud server 120 or other receiving device over the connection established in block 210. In some examples, the error code may also be stored locally on the primary device 104, including storage of the number of successful system boots since an error.

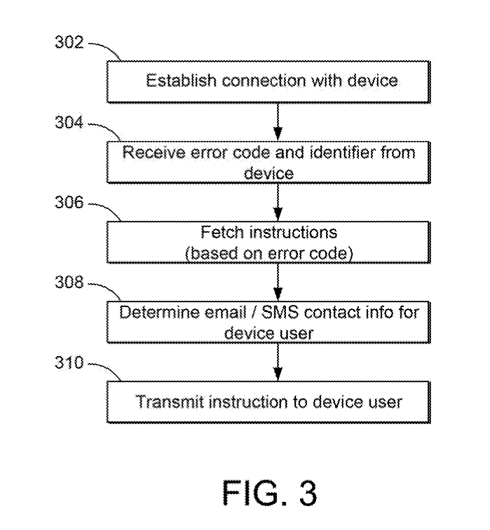

In block 214, the primary device 104 experiencing an error awaits instructions for resolving the error, or troubleshooting in general, as provided by the the cloud, server 120 and as transmitted to secondary device 114 for execution by a user on primary device 104, as discussed in more detail below with respect to FIG. 3.

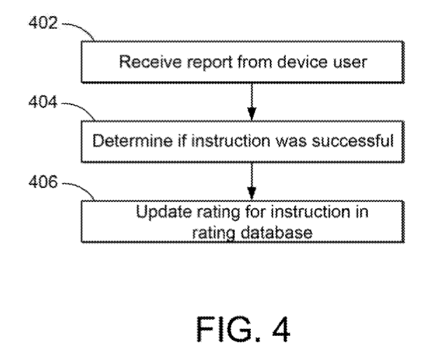

In block 216, the primary device 104, the secondary device 114, or the user in general of either device may report the success or failure of the instruction to the cloud server 120, once an instruction has been executed on the primary device 104, as discussed below in more detail with respect to FIG. 4.

FIG. 3 illustrates a flowchart of receiving an error code from a primary device, e.g., primary device 104, on a cloud service, e.g., cloud server 120. In block 302, a connection is established between the cloud server 120 and a primary device 104. In some examples, the connection may be between a network adapter of a primary device 104 and a network adapter of a cloud server 120, as transmitted over exemplary cloud 102 using a protocol such as TCP/IP, over a secure or non-secure communications protocol as discussed in more detail above.

In block 304, cloud server 120 receives an error code and an identifier from the primary device 104. In an example, the error code may be a numeric or alphanumeric code that can be looked up in a database, as discussed below in more detail, such as an error code for a processor, memory, or other component error or failure. In some examples, the identifier may be a unique system identifier associated with a primary device 104, or may be a unique identifier associated with the user of the primary device 104 that may be compared against an inventory of devices for that user.

In block 306, an instruction for the error code is fetched or looked up from an error code database containing instructions for resolving errors, e.g., error code database 122. Error code database 122 may be built, maintained, or curated by a cloud services provider, OEM, or technical support provider to support primary devices 104.

In some examples, error code database 122 may contain a single, instruction for each error code. In other cases, multiple instructions may be stored for each error code, in which case multiple instruction options may be sent to a user at once, or in a succession based on an order of priority, or based on stored success ratings, discussed below in more detail with respect to FIG. 4.

In block 308, contact information for the user of the primary device 104 reporting an error is determined. In some examples, the contact information may be a telephone number, SMS address, or e-mail address. In one example, the contact information may have been transmitted with the error code, e.g., in block 304, while in other cases the contact information may be determined or looked up in a database on, e.g., on contact information database 126. Contact information database 126 may associate system identifiers in a system inventory with user contact information.

In block 310, the instruction fetched in block 306 is transmitted to the user of the primary device 104 using the contact information determined in block 308, which the user may receive or access on a secondary device 114 such as a mobile device. Using the instructions received on the secondary device 114, the user may now carry out the instructions on the primary device 104 experiencing an error. For example, the instructions may direct the user to power down the primary device 104, open a case or compartment, re-seat a memory chip, and power up the primary device 104. In some examples, the user may be able to follow detailed, interactive, graphical, or video-based instructions, which may be contained in a link embedded in the instructions, on the secondary device 114 to resolve the error on primary device 104.

FIG. 4 illustrates a flowchart of receiving a report on a cloud service, e.g., cloud server 120, from a user, according to an example of the present disclosure

In an example, when a user, receives an instruction on a secondary device 114 and after a user carries out the instruction on a primary device 104, the instruction may prompt the user to input whether the instruction was successful in resolving the error on the primary device, or may prompt the user to rate the instruction based on success, failure, ease of understanding, or other factors.

In block 402, cloud server 120 may receive the report and, in block 404, determine if the instruction was successful or process other analytics based on the report received in block 402. For example, cloud server 120 may create a single internal success rating for an instruction based on the various feedback factors from a user or group of users, or from a device.

In block 406, a ratings database, e.g., ratings database 124, may be updated to reflect the report received in block 402. For example, for error codes with more than one instruction, ratings database 124 may promote or demote a particular instruction in an order of priority based on the feedback received in step 402 from a user or group of users, or from a device.

According to other examples, the report received in block 402 may be received from a user on a primary device, or directly from a primary device, once the error has been resolved, as opposed to a report from the secondary device 114.

FIG. 5 illustrates a schematic representation of a computing device that may be used as a platform for implementing or executing at least one of the processes depicted in FIGS. 2-4 according to an example of the present disclosure.

In an example, device 500 comprises a processor or CPU 502, memory 504, storage 506, power source 508, network adapter 510, embedded controller 512, BIOS or hypervisor 514, and management engine 516 or hardware-based technology for remotely managing and securing devices out-of-band. Management engine 516, in some examples, may comprise a separate compute core, e.g., as part of an embedded processor.

Some or all of the operations set forth in the figures may be contained as a utility, program, or subprogram in any desired computer readable storage medium, or embedded on hardware, in addition, the operations may be embodied by machine-readable instructions. For example, they may exist as machine-readable instructions in source code, object code, executable code, or other formats.

For example, device 500 may also comprise computer readable media, such as any suitable medium that participates in providing instructions to the processor(s) 502 for execution. For example, the computer readable medium may be non-volatile media, such as an optical or a magnetic disk; and volatile media, such as memory. Transmission media can also take the form of cabling, acoustic, light, or radio frequency waves. The computer readable medium may also store other machine-readable instructions, including instructions downloaded from a network or the internet.

The computer-readable medium may also store a firmware operating system, including network applications, that may perform basic tasks such as recognizing input from input devices, such as a keyboard or a keypad; sending output to a display; keeping track of files and directories on a computer readable medium; controlling peripheral devices, such as drives, printers, or image capture devices; and managing traffic on a bus. The network applications may include various components for establishing and maintaining network connections, such as machine readable instructions for implementing communication protocols including but not limited to TCP/IP, HTTP, HTTPS, Ethernet, USB, and FireWire.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What claimed is:

1. A method of providing an instruction to resolve a computing device error, comprising:
establishing a connection with a first computing device;
receiving an error code and an identifier from the first computing device;
fetching an instruction associated with the error code;
determining contact information for a user of the first computing device; and
transmitting the instruction to the user of the first computing device, wherein transmitting the instruction to the user of the first computing device comprises transmitting the instruction to a second computing device.

2. The method according to claim 1, wherein the error code and the identifier are received prior to a system firmware launch on the first computing device.

3. The method according to claim 1, wherein the second computing device is a mobile device.

4. The method according to claim 1, wherein the second computing device is an e-mail server.

5. The method according to claim 1, wherein the second computing device is an SMS server.

6. The method according to claim 1, further comprising receiving a report from a user of the second computing device following execution of the instruction on the first computing device.

7. The method according to claim 6, further comprising determining if the instruction was successful in resolving an error on the first computing device.

8. The method according to claim 6, further comprising updating a rating database of instructions.

9. The method according to claim 1, wherein the contact information of the user of the first computing device is an SMS address.

10. The method according to claim 1, wherein the contact information of the user of the first computing device is an e-mail address.

11. A computing device comprising:
an embedded controller to determine an error code; and
a network adapter to transmit the error code and a system identifier to a remote computing device to fetch an instruction for the error code to be transmitted to a secondary device;
a processor; and
a memory,
wherein the network adapter is to transmit the error code and system identifier
without accessing an operating system.

12. The computing device according to claim 11, wherein the network adapter is to transmit the error code and system identifier prior to a launch of firmware.

13. The computing device according to claim 11, wherein the network adapter is to transmit the error code and system identifier while the computing device is in a low-power mode.

14. The computing device according to claim 11, wherein the network adapter is to transmit the error code and system identifier while the computing device is in an off mode.

15. A non-transitory computer readable storage medium on which is embedded a computer program, said computer program to provide an instruction to resolve a computer device error, said computer program comprising a set of instructions to:
establish a connection with a first computer device;
receive an error code and an identifier from the first computer device;
fetch an instruction associated with the error code from a database of error codes and instructions;
determine contact information for a user of the first computer device; and
transmit the instruction to the user of the first computer device through a second computer device.
